(19) United States
(12) Patent Application Publication
(10) Pub. No.: US 2002/0191782 A1
(43) Pub. Date: Dec. 19, 2002

(54) Cradle device for a cellular telephone

(76) Inventors: Larry J. Beger, Lake Forest, IL (US); Shen Te Chang, Shu-Lin City (TW)

Correspondence Address: BARNES & THORNBURG, 2600 CHASE PLAZA, 10 LASALLE STREET, CHICAGO, IL, 60603

(21) Appl. No.: 10/225,968

(22) Filed: Aug. 22, 2002

Related U.S. Application Data
(63) Continuation-in-part of application No. 10/044,118, filed on Jan. 11, 2002.
(60) Provisional application No. 60/287,530, filed on Apr. 30, 2001.

(51) Int. Cl. H04M 1/00

(52) U.S. Cl. 379/454; 379/441

(57) ABSTRACT

A cradle for a cellular phone, a main body for engaging the cellular phone, and an adjustable supporting member for supporting the main body and the cellular phone when the cellular phone is engaged with the main body. The supporting member is adapted to be coupled to a power source. The supporting member includes a first member and a second member. The first member is pivotably associated with the second member and with the main body. The first member desirably is in the form of an extension member and the second member desirably is adapted to plug into the power source. The cradle desirably also includes a cord electrically connecting the cellular phone and the main body, the cord extending externally of the main body and the cellular phone. Desirably, the cradle includes a pair of releasable locks for preventing pivoting so that the main body can be positioned at a desired position and orientation. Desirably, the cradle also includes an adjustable clamp for adjustably engaging the cellular phone.

This application is a continuation-in-part application of U.S. patent application Ser. No. 10/044,118, filed on Jan. 11, 2002, which claims the benefit of U.S. provisional patent application serial No. 60/287,530, filed on Apr. 30, 2001.

### BACKGROUND

The present invention relates generally to a cradle for a cellular telephone, and, in particular, to a cradle that can be used in a vehicle or the like. Cellular telephone cradles that permit hands-free use of the cellular telephone in a vehicle are well known in the marketplace. The cradles typically include a body that engages and electrically connects to the telephone, and a support member for the body that plugs into a cigarette lighter or other power source. The cradles include a speaker and a microphone to facilitate hands-free telephone conversation. Examples of cellular telephone cradles are described in U.S. Pat. Nos. 5,903,645 and 6,138,041.

### SUMMARY

The present invention provides a cradle for supplying power to a cellular phone. The cradle comprises a main body for engaging the cellular phone and an adjustable supporting member for supporting the main body and the cellular phone when the cellular phone is engaged with the main body. The supporting member is adapted to be coupled to a power source, such as, for example, a vehicle cigarette lighter or the like, to supply power to recharge the cellular telephone. The supporting member includes a first member and a second member. The first member is pivotably associated with the second member and with the main body. In a preferred embodiment, the first member pivots relative to the main body in a first pivoting direction and pivots relative to the second member in a second pivoting direction, and desirably the first and second pivoting directions are generally perpendicular to each other. The first member desirably is in the form of an extension member and the second member desirably is adapted to plug into the power source. The cradle desirably also includes a cord electrically connecting the cellular phone and the main body, the cord extending externally of the main body and the cellular phone.

Desirably, the cradle includes at least one releasable lock to releasably prohibit pivoting in at least one direction. In a preferred embodiment, there are two releasable locks, namely a first releasable lock for releasably locking the main body to the first member to prevent pivoting between the main body and the first member, and a second releasable lock for releasably locking the first member to the second member to prevent pivoting between the first member and the second member. The first releasable lock may, for example, comprise a first fastener extending through at least one first aperture defined by the main body and at least one first aperture defined by the first member, the first fastener threadingly associated with at least one of the main body and the first member; and the second releasable lock may, for example, comprise a second fastener extending through at least one second aperture defined by the second member and at least one second aperture defined by the first member, the second fastener threadingly associated with at least one of the second member and the first member. Each of the releasable locks may include a washer associated with the respective fastener to cause the respective threading associations. Desirably, the first releasable lock further comprises a first knob associated with the first fastener and the second releasable lock further comprises a second knob associated with the second fastener. Desirably, the cradle also includes an adjustable clamp for adjustably engaging the cellular phone.

Additional features of the invention will become apparent to those skilled in the art upon consideration of the following detailed description of referred embodiments exemplifying the best mode of carrying out the invention as presently perceived.

### BRIEF DESCRIPTION OF DRAWINGS

FIG. 1 is a front perspective view of a cradle in accordance with an embodiment of the invention;

FIG. 2 is a rear perspective view of the cradle of FIG. 1;

FIG. 3 is a bottom perspective view of the cradle of FIG. 1 with the cord removed;

FIG. 4 is a top perspective view of the cradle of FIG. 1 with the cord removed, illustrating a plug member pivoted relative to the extension member of the support member;

FIG. 5 is a rear perspective view of the cradle of FIG. 1, with the back cover and main gear removed;

FIG. 6 is a rear perspective view of the cradle of FIG. 1, with the back cover removed;

FIG. 7 is an exploded view of the main body of the cradle of FIG. 1;

FIG. 8 is a perspective view of the drive wheel pin of the main body of FIG. 7; and

FIG. 9 is a perspective view of the locking member of the main body of FIG. 7.

### DETAILED DESCRIPTION OF ILLUSTRATIVE EMBODIMENTS

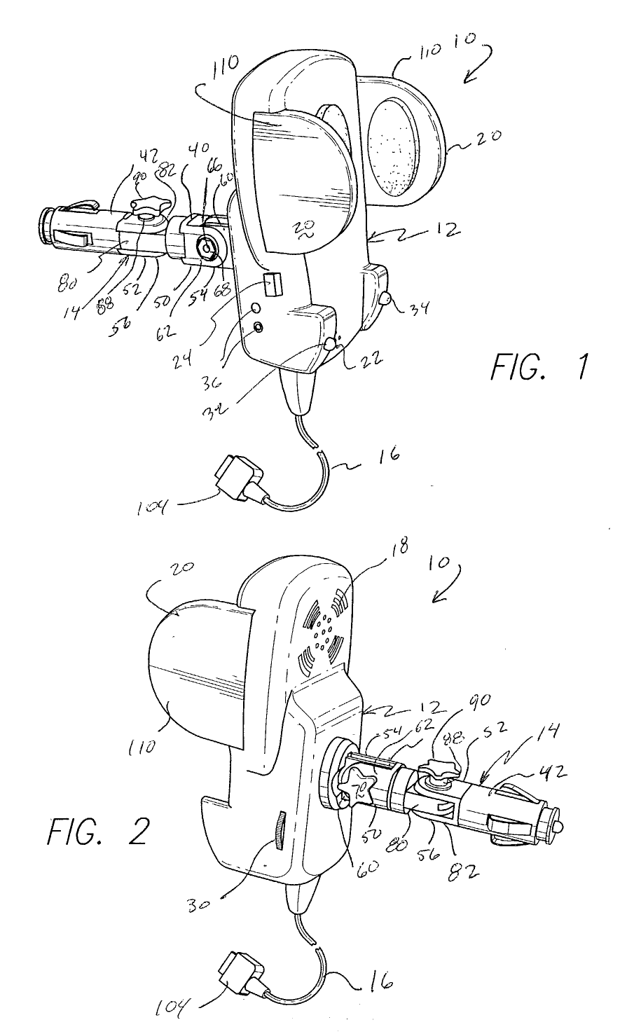

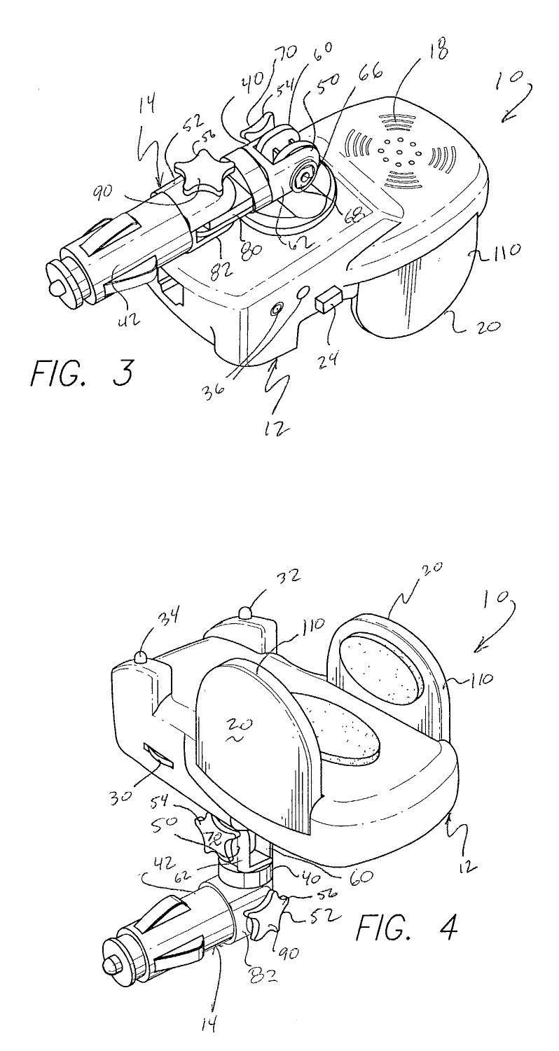

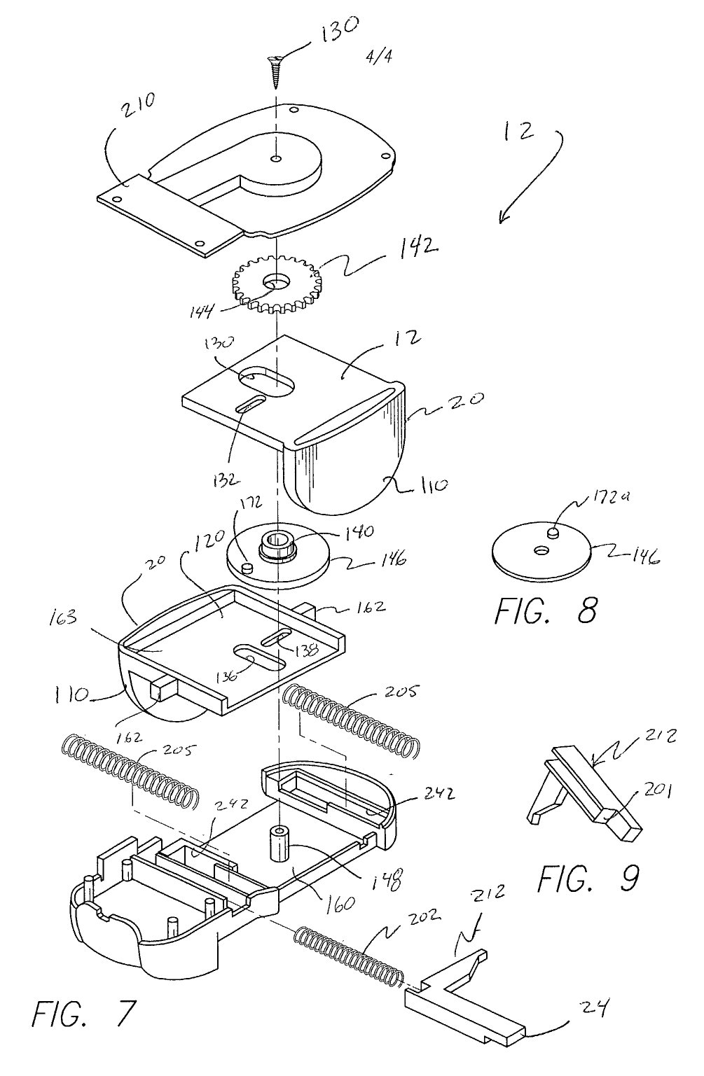

FIGS. 1-8 illustrate a cradle 10 in accordance with a preferred embodiment of the invention comprising generally a main body 12 and a support member 14. The cradle 10 desirably also includes a cord 16 for electrically connecting to a cellular telephone. The cradle 10 may be used to provide power to the cellular telephone to, for example, permit hands-free operation of the cellular telephone, to recharge the battery of the cellular telephone, or both. The main body 12, the support member 14 and the cord 16 may have any suitable construction.

In the illustrated embodiment, for example, the main body 12 includes a speaker 18 desirably facing rearward at the top back of the main body 12, a clamp that may, for example, be in the form of adjustable “wings” 20 projecting from the front of the main body 12 that move laterally to adjustably grasp the side of the cellular phone, and a microphone 22 positioned at the lower front of the main body 12. The illustrated main body 12 may also include a button 24 that permits the adjustable wings 20 to readily release the cellular phone, a volume control thumb-wheel 30, a LED 32 to indicate whether the cradle 10 is receiving power, and an LED 34 to indicate whether the cradle is charging the phone. If desired, the main body 12 may also include jacks 36 for receiving headset and external power plugs.

The illustrated support member 14 includes a first member that may, for example, be in the form of an extension member 40 and a second member that may, for example, be in the form of a plug member 42. Plug member 42 desirably is compatible with an automobile lighter socket or other power source. Extension member 40 desirably is coupled on one end to the main body 12 and coupled on the other end to the plug member 42. In accordance with a preferred embodiment of the invention, the support member 14 is pivotable at two different pivotal connections desirably in the form of hinges 50 and 52 to facilitate ready adjustment of the main body 12 at a desired position. Additionally, the cradle 10 includes a pair of releasable locks 54 and 56, and each lock is associated with a respective hinge 50 and 52 to releasably lock the support member 14 in place to prevent pivoting once the support member 14 has been adjusted to a desired location and orientation. The illustrated cord 16 is a linear pliable cord. The cord may be a coiled cord in accordance with alternative embodiments.

The extension member 40, for example, may be pivotally connected to the main body 12 in any suitable manner and the extension member may be pivotally connected to the plug member 42 in any suitable manner so that the cradle 10 can be readily positioned at a desired orientation and location. Desirably, the extension member 40 is pivotable back and forth in a first direction relative to the main body 12, the extension member is pivotable back and forth in a second direction relative to the plug member 42, and the first and second directions are generally perpendicular.

In the illustrated embodiment, the pivotal connections or hinges 50 and 52 are oriented to operate in generally perpendicular directions. Hinge 50 includes a hinge knuckle 60 of the main body 12, and the end portion 62 of the extension member 40 is forked to define a cavity to receive the hinge knuckle. The hinge knuckle 60 and the end portion 62 define a series of apertures which are aligned to receive a pintle desirably in the form of a threaded fastener 66 which engages a threaded washer 68 associated with one of the apertures and which is adapted to releasably lock to the washer to releasably lock the hinge 50 once the hinge has been oriented to the desired position. A manual knob 70 desirably is secured to the fastener 66 to facilitate manual rotation of the fastener to releasably lock and unlock the hinge 50.

Similarly, the hinge 52 includes a hinge knuckle 80 associated with the extension member 40, and the end portion 82 of the plug member 42 is forked to define a cavity to receive the hinge knuckle. The hinge knuckle 80 and the end portion define a series of apertures which are aligned to receive a pintle desirably in the form of a threaded fastener 88 which engages a threaded washer associated with one of the apertures and which is adapted to releasably lock to the washer to releasably lock the hinge 52 once the hinge has been oriented to the desired position. If desired, the hinge 52 may also include teeth (not shown) formed on one or both of the outer sides of the knuckle 80 that mate with teeth (not shown) formed on one or both of the inside of the forks to facilitate adjustment of the hinge. A manual knob 90 desirably is secured to the fastener 88 to facilitate manual rotation of the fastener to releasably lock and unlock the hinge 52.

Accordingly, the main body 12 of the cradle 10 in accordance with a preferred embodiment can be oriented relative to the extension member 40 and the plug member 42 and releasably locked in place relative to the extension member and the plug member. The hinges 50 and 52 desirably operate in generally perpendicular directions so that the main body 12 can pivot in its generally longitudinal and lateral directions. In the illustrated embodiment, for example, hinge 50 allows pivoting of the main body 12 generally in the longitudinal direction of the main body relative to the extension member 40, and hinge 52 allows pivoting of the extension member 40 relative to the plug member 42 generally in the lateral direction of the main body. Once the desired position of the hinges 50 and 52 are achieved, the knobs 70 and 90 are each turned to releasably lock the hinges in place. Each hinge 50 and 52 desirably can be readily unlocked and locked independently of the other hinge 50 and 52.

In the illustrated embodiment, two wires supply d.c. power from the lighter socket to main body 12. Desirably, there is a connection at the bottom of the main body 12 for attaching a connector 104 of the cord 16 that may be connected to the phone through its power/data connection.

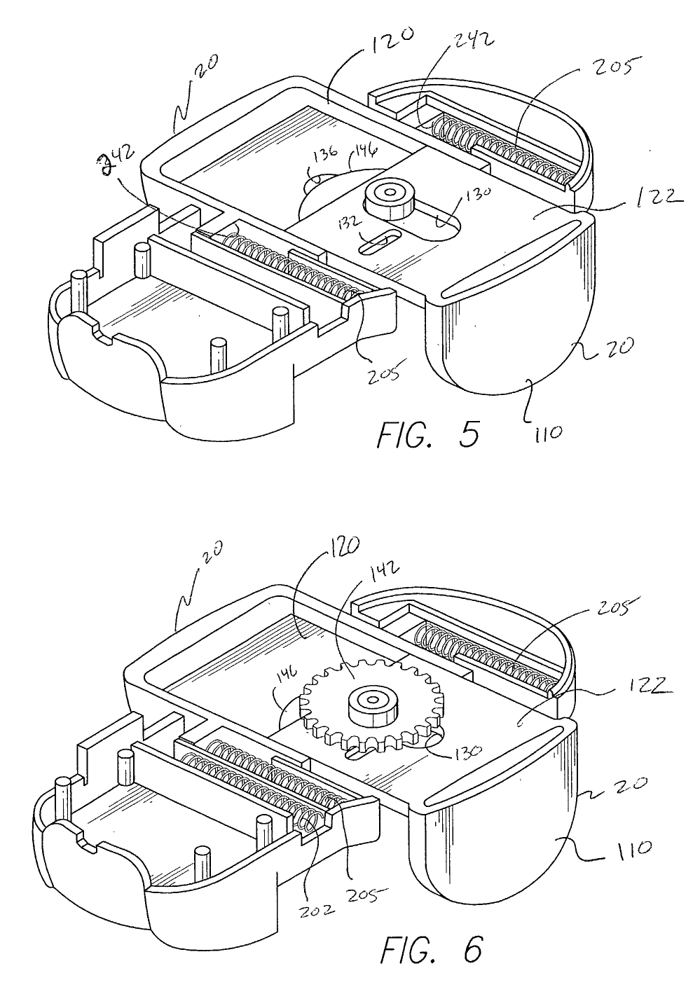

The mechanism for moving wings 20 to grasp and release the cellular phone in accordance with a preferred embodiment is shown in FIGS. 5, 6 and 7. With this embodiment, each wing, 20, comprises a grasping portion 110 that projects outward from the main body 12, connected to back portions 120 and 122 that are coplanar with and inside the main body 12. Back portion 122 is a rectangular plate with elliptical hole 130 and elliptical slot 132. Elliptical hole 130 has a major axis in the direction of travel of wing 20. Elliptical slot 132 has a major axis perpendicular to the major axis of elliptical hole 130. Back portion 120 is also a rectangular plate and has elliptical hole 136 and elliptical slot 138. Elliptical hole 136 has a major axis in the direction of travel of wing 20 and the major axis of elliptical slot 138 is perpendicular to the wing 20 direction of travel.

A hollow shaft 140 with integral key passes through elliptical hole 130. Mounted on shaft 140 is a locking gear 142 with receiving hole and keyway 144 and drive wheel 146. In the preferred embodiment, keyed hollow shaft 140 and drive wheel 146 are an integral plastic part. Hollow shaft 140 is mounted on pin 148 projecting back from the front cover 160 of main body 12 and passing through hole 136.

Drive wheel 146 has two drive pins 172 and 172a positioned 180 degrees apart. When assembled, shaft 140 passes though holes 130 and 136 of the back portions of the two wings 20. Drive pin 172 is inserted in elliptical slot 132 and drive pin 172a is inserted in elliptical slot 138. Rotation of drive wheel 146 causes wings 20 to move laterally. In the preferred embodiment shown in FIG. 6, the drive wheel is located between back portions 120 and 122 and drive pins 172 and 172a are on opposite faces of drive wheel 146; however, one skilled in the art would recognize alternate equivalent drive wheel locations and slot configurations.

Front cover 160 has one or more channels 242 to hold springs 205. Springs 205 are compressed, one end pressing against one end of channel 242 and at the other end pressing against tabs 162, which project from back portion 163 of wing 20. The force of springs 205 tend to push wing 20 into the open position. Movement of wing 20 into the open position, acting against drive pin 172a causes drive wheel 146 to rotate and push wing 20 into the open position also.

To hold the cellular telephone in position, the user places the telephone against main body 12, between wings 110 and 112 and squeezes wings 110 and 112 together. When the user releases wings 110 and 112, they are held in place by pawl 212 acting on the teeth of gear 142, which prevents shaft 140 and drive wheel 146 from rotating and prevents the wings from opening. Pawl 212 is held against the teeth of gear 142 by spring 202, positioned in groove 180 on front cover 160. Spring 202 is compressed between the end of groove 180 and locking member 201, which comprises pawl 212 and release button 224. Pressing release button 24 causes pawl 212 to disengage from the teeth of locking gear 142, permitting wings 20 to open as described above.

Back cover plate 210 holds the above described assembly in its assembled configuration with screw 130 passing through back cover 210, shaft 140, and threading into pin 148.

When the illustrated cradle 10 is connected to the power source and the cellular phone is connected to the cord 16, the cradle may be used for hands-free operation of the cellular phone and the power source desirably also recharges the cellular phone and, in particular, the battery of the cellular phone. In accordance with alternative embodiments, the cradle may omit or otherwise not provide either of these functions. For example, if desired, the speaker and the microphone may be omitted such that the cradle does not permit hands-free operation of the cellular phone. With this embodiment, the cradle is used to recharge the cellular phone or to otherwise supply power to the cellular telephone. If desired, during use, the cellular phone may be disengaged from such cradle, and may remain connected to the cord so that it continues to receive power while in use. Alternatively, the cradle may be constructed such that it does not recharge, but rather simple permits hands-free operation of the cellular phone while it is engaged with the cradle.

Although the invention has been described and illustrated in detail with reference to preferred embodiments, it is to be clearly understood that the same is by way of illustration and example only, and is not to be taken by way of limitation. The spirit and scope of the present invention are to be limited only by terms of the following claims.

What is claimed:

1. A cradle for supplying power to a cellular phone, the cradle comprising:
(a) a main body for engaging the cellular phone;
(b) an adjustable supporting member for supporting the main body and the cellular phone when the cellular phone is engaged with the main body, the supporting member adapted to be coupled to a power source, the supporting member including a first member and a second member, the first member being pivotably associated with the second member and with the main body.

2. The cradle of claim 1 further comprising a cord electrically connecting the cellular phone and the main body, the cord extending externally of the main body and the cellular phone.

3. The cradle of claim 1 wherein the first member pivots relative to the main body in a first pivoting direction and the first member pivots relative to the second member in a second pivoting direction.

4. The cradle of claim 3 wherein the first and second pivoting directions are generally perpendicular to each other.

5. The cradle of claim 1 further comprising a releasable lock for releasably locking the first member to the cradle to prevent pivoting between the first member and the cradle.

6. The cradle of claim 5 wherein the releasable lock comprises a fastener extending through at least one aperture defined by the second member and at least one aperture defined by the first member, the fastener threadingly associated with at least one of the second member and the first member.

7. The cradle of claim 1 further comprising a releasable lock for releasably locking the second member to the first member to prevent pivoting between the second member and the first member.

8. The cradle of claim 7 wherein the releasable lock comprises a fastener extending through at least one aperture defined by the second member and at least one aperture defined by the first member, the fastener threadingly associated with at least one of the second member and the first member.

9. The cradle of claim 1 further comprising:
(a) a first releasable lock for releasably locking the first member to the cradle to prevent pivoting between the first member and the cradle; and
(b) a second releasable lock for releasably locking the second member to the first member to prevent pivoting between the second member and the first member.

10. The cradle of claim 9 wherein the first releasable lock comprises a first fastener extending through at least one first aperture defined by the main body and at least one first aperture defined by the first member, the first fastener threadingly associated with at least one of the main body and the first member, and wherein the second releasable lock comprises a second fastener extending through at least one second aperture defined by the second member and at least one second aperture defined by the first member, the second fastener threadingly associated with at least one of the second member and the first member.

11. The cradle of claim 10 wherein the first releasable lock further comprises a first knob associated with the first fastener and the second releasable lock further comprises a second knob associated with the second fastener.

12. The cradle of claim 1 wherein the main body includes a clamp for engaging the cellular phone.

13. The cradle of claim 1 wherein the second member is adapted to plug into a power source.

14. A cradle for supplying power to a cellular phone, the cradle comprising:
(a) a main body for engaging the cellular phone;
(b) an adjustable supporting member for supporting the main body and the cellular phone when the cellular phone is engaged with the main body, the supporting member including a plug member adapted to be connected to a power source and an extension member, the extension member being pivotably associated with the plug member and with the main body;
(c) a first releasable lock for releasably locking the extension member to the main body to prevent pivoting between the main body and the extension member; and
(d) a second releasable lock for releasably locking the extension member to the plug member to prevent pivoting between the extension member and the plug member.

15. The cradle of claim 14 further comprising a cord electrically connecting the cellular phone and the main body, the cord extending externally of the main body and the cellular phone.

16. The cradle of claim 14 wherein the extension member pivots relative to the main body in a first pivoting direction and the extension member pivots relative to the plug member in a second pivoting direction, the first pivoting direction being generally perpendicular to the second pivoting member.

17. The cradle of claim 14 wherein the first releasable lock comprises a first fastener extending through at least one first aperture defined by the main body and at least one first aperture defined by the extension member, the first fastener threadingly associated with at least one of the main body and the extension member and wherein the second releasable lock comprises a second fastener extending through at least one second aperture defined by the plug member and at least one second aperture defined by the extension member, the second fastener threadingly associated with at least one of the plug member and the extension member.

18. The cradle of claim 17 wherein the first releasable lock further comprises a first knob associated with the first fastener and the second releasable lock further comprises a second knob associated with the second fastener.

19. The cradle of claim 14 wherein the main body includes a pair of adjustable wings for engaging the cellular phone.

20. A cradle for supplying power to a cellular phone, the cradle comprising:
(a) a main body for engaging the cellular phone;
(b) an adjustable supporting member for supporting the main body and the cellular phone when the cellular phone is engaged with the main body, the supporting member including a plug member adapted to be connected to a power source and an extension member, the extension member being pivotably associated with the plug member and with the main body;
(c) a first releasable lock for releasably locking the main body to the extension member to prevent pivoting between the main body and the extension member;
(d) a second releasable lock for releasably locking the extension member to the plug member to prevent pivoting between the extension member and the plug member; and
(e) a cord electrically connecting the cellular phone and the main body, the cord extending externally of the main body and the cellular phone.

21. The cradle of claim 20 wherein the first releasable lock comprises a first fastener extending through at least one first aperture defined by the main body and at least one first aperture defined by the extension member, the first fastener threadingly associated with at least one of the main body and the extension member and wherein the second releasable lock comprises a second fastener extending through at least one second aperture defined by the plug member and at least one second aperture defined by the extension member, the second fastener threadingly associated with at least one of the plug member and the extension member.

22. The cradle of claim 21 wherein the first releasable lock further comprises a first knob associated with the first fastener and the second releasable lock further comprises a second knob associated with the second fastener.

23. The cradle of claim 21 wherein the extension member pivots relative to the main body in a first pivoting direction and the extension member pivots relative to the plug member in a second pivoting direction, the first pivoting direction being generally perpendicular to the second pivoting member.
